(19) United States
(12) Patent Application Publication
(10) Pub. No.: US 2026/0353265 A1
(43) Pub. Date: Nov. 5, 2026

(54) SECURITY COUNTER MEASURE FOR DISTRIBUTED NETWORK SLICE ADMISSION CONTROL

(71) Applicant: Nokia Technologies Oy, Espoo (FI)

(72) Inventors: Jing PING, Chengdu (CN); Saurabh KHARE, Bangalore (IN); Rajesh Babu NATARAJAN, Bangalore (IN); Dinh Thai BUI, Massy (FR)

(21) Appl. No.: 19/120,748

(22) PCT Filed: Oct. 14, 2022
(86) PCT No.: PCT/CN2022/125268

§ 371 Date: Apr. 11, 2025

(51) Int. Cl. H04W 48/18; H04W 12/06; H04W 84/04

(52) U.S. Cl. CPC H04W 48/18; H04W 12/06; H04W 84/042

(57) ABSTRACT

Example embodiments of the present disclosure relate to security countermeasure for distributed network slice admission control (NSAC). Specifically, a first device receives a first message for updating or reporting an admission number of user equipments (UEs) or packet data unit (PDU) sessions associated with a serving area corresponding to the second device from a second device, where the admission number is specific to a slice or single network slice selection assistance information (S-NSSAI). Then the first device determines a first number of UEs or PDU sessions specific to the slice or the S-NSSAI counted by at least one third device, such that the admission number is verified with the first number, and performs an admission control procedure based at least in part on the first number.

### FIELDS

Various example embodiments of the present disclosure generally relate to the field of telecommunication and in particular, to methods, devices, apparatuses and computer readable storage medium for security countermeasure for distributed network slice admission control (NSAC).

### BACKGROUND

The third generation partnership project (3GPP) 5th generation (5G) technology is the next generation of radio systems and network architecture that can deliver extreme broadband, ultra-robust and low latency connectivity. The 5G technology improves a variety of telecommunication services offered to the end users and helps to support massive broadband that delivers gigabytes of bandwidth per second on demand for both the uplink and downlink transmissions.

In the 5G wireless network, network slicing is a concept for running multiple logical networks as virtually independent business operations on a common physical infrastructure. Generally speaking, a slice may be identified by single network slice selection assistance information (S-NSSAI). Further, the NSAC procedure is needed for the slice network. That is, the number of user equipments (UEs) or packet data unit (PDU) sessions is controlled by using a pre-configured maximum number of UEs or PDU sessions. However, if the number of UEs or PDU sessions is faked or incorrect, then the performance of the slice network would be decreased thereby.

### SUMMARY

In a first aspect of the present disclosure, there is provided a first device. The first device comprises at least one processor; and at least one memory storing instructions that, when executed by the at least one processor, cause the first device at least to perform: receiving, from a second device, a first message for updating or reporting an admission number of UEs or PDU sessions associated with a serving area corresponding to the second device, the admission number being specific to a slice or S-NSSAI; and determining, a first number of UEs or PDU sessions specific to the slice or the S-NSSAI counted by at least one third device, such that the admission number is verified with the first number; and performing an admission control procedure based at least in part on the first number.

In a second aspect of the present disclosure, there is provided a third device. The third device comprises at least one processor; and at least one memory storing instructions that, when executed by the at least one processor, cause the third device at least to perform: receiving, from a first device, a second message for requesting a second number of UEs or PDU sessions associated with a serving area corresponding to a second device, the second number being counted by the third device and being specific to a slice or S-NSSAI; generating a third message indicating the second number; and transmitting the third message to the second device.

In a third aspect of the present disclosure, there is provided a fourth device. The fourth device comprises at least one processor; and at least one memory storing instructions that, when executed by the at least one processor, cause the fourth device at least to perform: receiving, from user equipment, a registration request; and in response to a complete of registration for the user equipment, transmitting, to a third device, a fifth message comprising information on one or more allowed S-NSSAI.

In a fourth aspect of the present disclosure, there is provided a fifth device. The fifth device comprises at least one processor; and at least one memory storing instructions that, when executed by the at least one processor, cause the fifth device at least to perform: receiving a fourth message from a first device, the fourth message indicating that an anomaly has occurred at a second device or a serving area where the second device is located, the second device being a distributed admission control device; and triggering a security procedure to handle the anomaly.

In a fifth aspect of the present disclosure, there is provided a sixth device. The sixth device comprises at least one processor; and at least one memory storing instructions that, when executed by the at least one processor, cause the sixth device at least to perform: collecting, from a plurality of devices, information associated with a plurality of numbers of user equipment or PDU sessions specific to a slice or S-NSSAI; and determining, based at least in part on the information, an operation status of a second device being a distributed admission control device.

In a sixth aspect of the present disclosure, there is provided a method. The method comprises: at a first device, receiving, from a second device, a first message for updating or reporting an admission number of UEs or PDU sessions associated with a serving area corresponding to the second device, the admission number being specific to a slice or S-NSSAI; and determining, a first number of UEs or PDU sessions specific to the slice or the S-NSSAI counted by at least one third device, such that the admission number is verified with the first number; and performing an admission control procedure based at least in part on the first number.

In a seventh aspect of the present disclosure, there is provided a method. The method comprises: receiving, at a third device and from a first device, a second message for requesting a second number of UEs or PDU sessions associated with a serving area corresponding to a second device, the second number being counted by the third device and being specific to a slice or S-NSSAI; generating a third message indicating the second number; and transmitting the third message to the second device.

In an eighth aspect of the present disclosure, there is provided a method. The method comprises: receiving, at a fourth device, from user equipment, a registration request; and in response to a complete of registration for the user equipment, transmitting, to a third device, a fifth message comprising information on one or more allowed S-NSSAI.

In a ninth aspect of the present disclosure, there is provided a method. The method comprises: at a fifth device, receiving a fourth message from a first device, the fourth message indicating that an anomaly has occurred at a second device or a serving area where the second device is located, the second device being a distributed admission control device; and triggering a security procedure to handle the anomaly.

In a tenth aspect of the present disclosure, there is provided a method. The method comprises: collecting, at a sixth device and from a plurality of devices, information associated with a plurality of numbers of user equipments or PDU sessions specific to a slice or S-NSSAI; and determining, based at least in part on the information, an operation status of a second device being a distributed admission control device.

In an eleventh aspect of the present disclosure, there is provided a first apparatus. The first apparatus comprises means for receiving, from a second apparatus, a first message for updating or reporting an admission number of UEs or PDU sessions associated with a serving area corresponding to the second apparatus, the admission number being specific to a slice or S-NSSAI; and means for determining, a first number of UEs or PDU sessions specific to the slice or the S-NSSAI counted by at least one third apparatus, such that the admission number is verified with the first number; and means for performing an admission control procedure based at least in part on the first number.

In a twelfth aspect of the present disclosure, there is provided a third apparatus. The third apparatus comprises means for receiving, from a first apparatus, a second message for requesting a second number of UEs or PDU sessions associated with a serving area corresponding to a second apparatus, the second number being counted by the third apparatus and being specific to a slice or S-NSSAI; means for generating a third message indicating the second number; and means for transmitting the third message to the second apparatus.

In a thirteenth aspect of the present disclosure, there is provided a fourth apparatus. The fourth apparatus comprises means for receiving, from user equipment, a registration request; and means for in response to a complete of registration for the user equipment, transmitting, to a third apparatus, a fifth message comprising information on one or more allowed S-NSSAI.

In a fourteenth aspect of the present disclosure, there is provided a fifth apparatus. The fifth apparatus comprises means for receiving a fourth message from a first apparatus, the fourth message indicating that an anomaly has occurred at a second apparatus or a serving area where the second apparatus is located, the second apparatus being a distributed admission control apparatus; and means for triggering a security procedure to handle the anomaly.

In a fifteenth aspect of the present disclosure, there is provided a sixth apparatus. The sixth apparatus comprises means for collecting, from a plurality of apparatuses, information associated with a plurality of numbers of user equipment or PDU sessions specific to a slice or S-NSSAI; and means for determining, based at least in part on the information, an operation status of a second apparatus being a distributed admission control apparatus.

In a sixteenth aspect of the present disclosure, there is provided a computer readable medium. The computer readable medium comprises instructions stored thereon for causing an apparatus to perform at least the method according to the sixth aspect.

In a seventeenth aspect of the present disclosure, there is provided a computer readable medium. The computer readable medium comprises instructions stored thereon for causing an apparatus to perform at least the method according to the seventh aspect.

In an eighteenth aspect of the present disclosure, there is provided a computer readable medium. The computer readable medium comprises instructions stored thereon for causing an apparatus to perform at least the method according to the eighth aspect.

In a nineteenth aspect of the present disclosure, there is provided a computer readable medium. The computer readable medium comprises instructions stored thereon for causing an apparatus to perform at least the method according to the ninth aspect.

In a twentieth aspect of the present disclosure, there is provided a computer readable medium. The computer readable medium comprises instructions stored thereon for causing an apparatus to perform at least the method according to the tenth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2A illustrates a hierarchical NSACF architecture according to some example embodiments;

FIG. 2B illustrates a signaling chart for NSAC check of the maximum number of UEs according to some example embodiments;

FIG. 2C illustrates a signaling chart for NSAC check of the maximum number of PDU sessions according to some example embodiments;

FIG. 2D illustrates a signaling chart for redistribution of local maximum number according to some example embodiments;

FIG. 3 illustrates a signaling chart for communication according to some example embodiments of the present disclosure;

FIG. 4 illustrates another signaling chart for communication according to some example embodiments of the present disclosure;

FIG. 5 illustrates a flowchart of a method implemented at a first device according to some example embodiments of the present disclosure;

FIG. 6 illustrates a flowchart of a method implemented at a third device according to some example embodiments of the present disclosure;

FIG. 7 illustrates a flowchart of a method implemented at a fourth device according to some example embodiments of the present disclosure;

FIG. 8 illustrates a flowchart of a method implemented at a fifth device according to some example embodiments of the present disclosure;

FIG. 9 illustrates a flowchart of a method implemented at a sixth device according to some example embodiments of the present disclosure;

FIG. 10 illustrates a simplified block diagram of a device that is suitable for implementing example embodiments of the present disclosure; and FIG. 11 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “primary admission control device” refers to any entity/function/device/apparatus that is responsible for the admission control for at least one slice with the global maximum number value valid across service areas. In some example embodiments, the primary admission control device is located in a central area of the 5G core network/home public land mobile network (HPLMN). By way of example rather than limitation, the primary admission control device may be a primary NSACF.

Further, terms of “primary admission control device”, “primary NSACF”, “centralized NSACF” or “central NSACF” may be used interchangeably.

As used herein, the term “distributed admission control device” refers to any entity/function/device/apparatus that is responsible for the admission control for a serving area (or visited public land mobile network, VPLMN). In some example embodiments, the distributed admission control device is located at an edge of the network (such as, HPLMN or VPLMN) and may communicate with a primary admission control device. By way of example rather than limitation, the distributed admission control device may be a distributed NSACF.

Further, terms of “distributed admission control device”, “local admission control device”, “distributed NSACF” or “local NSACF” may be used interchangeably.

As used herein, the term “control device” refers to any entity/function/device/apparatus for control. In some example embodiments, the control device is a control plane component/device and used for controlling for a data plane, such as, a PDU session and so on.
that is responsible for control on signalling, sessions (such as, PDU session) and so on.

By way of example rather than limitation, the control device may be an access and mobility management function (AMF) or session management function (SMF).

As used herein, the term “user data management device” refers to any entity/function/device/apparatus that is responsible for maintaining the user data in the network. In some example embodiments, the user data management device may be located in a central area of the 5G core network/HPLMN. Further, in some example embodiments, the user data management device may be accessible by the primary admission control device, the control device(s), the analytics device(s) and so on. By way of example rather than limitation, the user data management device may be a user data management (UDM).

As used herein, the term “management device” refers to any entity/function/device/apparatus that is responsible for operation, administration, management, maintenance and so on. By way of example rather than limitation, the management device may be an operation administration and maintenance (OAM).

As used herein, the term “analytics device” refers to any entity/function/device/apparatus that may collect and analyze the log, trace, report, data and other running information in the network. In some example embodiments, the analytics device is operated based on artificial intelligence (AI)/machine learning (ML). By way of example rather than limitation, the analytics device may be a network data analytics function (NWDAF), management data analytics service (MDAS) producer and any AI/ML network function/node.

In 3GPP release 18, it is expected to enhance NSAC features with the following features: improved network control of the UE behavior and support deploying multiple NSACF. That is, there may be more than one service area associated with one S-NSSAI, for example, one PLMN is split into multiple service areas. In this event, there will be more than one NSACF handling the UE, and example scenarios include:
Multi-NSACF deployed within one PLMN: more than one service is defined within one PLMN. Further, for each service area, one NSACF or NSACF set is deployed for NSAC (including the control of the maximum number of UEs or PDU sessions).
Roaming: when the user equipment resides at the visited PLMN (VPLMN), the NSAC (such as, the maximum number of PDU sessions) may be controlled by the NSACF in the VPLMN (e.g. for local break out PDU session), or the NSACF in the HPLMN (e.g. for home-routed PDU session).
Evolved packet system (EPS) interworking: when the user equipment establishes a home-routed PDN connection at the EPS network and move to 5G system later, the NSACF (for example, the maximum number of user equipment) selected by the SMF+ packet data network gateway control plane function (PGW-C) and AMF may be different.

Further, as discussed above, generally speaking, a slice may be identified by S-NSSAI, and further for one slice/S-NSSAI, there is only one configured global maximum allowed number value for NSAC (i.e., a maximum number of UEs or PDU sessions). In case of multi-NSACF, the admission control is aimed to match the allocated quota. However, potential issues of denial of service (DOS) attacks to legitimate user equipment when the additional features are added to the admission control mechanism. For example, malicious distributed NSACF of a serving area may provide faked or false information the number of UEs or PDU sessions.

In some cases, the security control in different serving areas/(V)PLMNs may be different. In particular, the security control at the edge of the network is not as strict as that in data center, which causes that attack surface at the edge of the network may be higher than the data center. Thus, a compromised/malicious distributed NSACFs in some high risky serving areas/networks may trigger DoS or other attacks on the home network.

For example, the compromised/malicious distributed NSACFs at the edge of the network may fake the case that the number of UEs is reaching the local maximum number allocated to the serving area, and may transmit a message of Nnsacf_NSAC_NumberUpdate_Request to the primary NSACF for a new quota. The primary NSACF may allocate new quota to the compromised/malicious distributed NSACFs. As a result, the available quota for the other normal serving areas may be decreased. In other words, the admission service for the normal serving areas may be impacted as the global maximum number has been exhausted by the compromised/malicious distributed NSACF(s).

In addition, in some cases, even if the user equipment does not use a network slice, the user equipment may be still counted against quota usage of S-NSSAIs where it is registered.

In summary, there are a plurality of cases which may cause an incorrect number of UEs or PDU sessions. In case that the number of UEs or PDU sessions is faked or incorrect, the performance of the network would be decreased thereby.

In view of the above, it is desirable to propose a solution to identify the faked or incorrect number of user equipment/PDU sessions.

According to some example embodiments of the present disclosure, there is provided a solution for security countermeasure of distributed for distributed NSAC network. Specifically, a device (such as, a primary NSACF or an analytics device) may obtain information associated with more accurate number(s) of user equipment or PDU sessions specific to a slice or S-NSSAI. With such information, the compromised/malicious distributed NSACF(s)/AMF(s)/SMF(s) may be identified.

Principles and implementations of the present disclosure will be described in detail below with reference to the figures.

It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### Example Environment

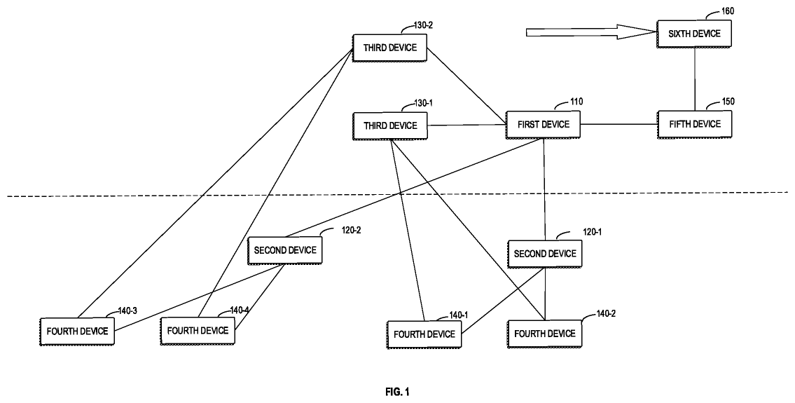

FIG. 1 illustrates an example communication environment 100 in which example embodiments of the present disclosure can be implemented.

In the specific example of FIG. 1, communication environment 100 compromises a plurality of communication devices, a first device 110 and more than one second device (such as, the second devices 120-1 and 120-2), more than one third device (such as, the third devices 130-1 and the 130-2), one or more fifth devices (such as, the fifth device 150) and one or more sixth device (such as, the sixth device 160).

In the following, for the purpose of illustration, some example embodiments are described with the first device 110 operating as a primary admission control device (such as, primary NSACF), the second device 120 operating as a distributed admission control device (such as, distributed NSACF, which may be implemented as one NSACF instance or one NSACF set), the third device 130 operating as a user data management device (such as, UDM), the fifth device 150 operating as a management device (such as, OAM), and the sixth device 160 operating as an analytics device (such as, NWDAF or MDAS producer).

In some example embodiments, each second device 120 corresponds to a serving area/VPLMN. Further, in some example embodiments, each serving area/VPLMN may comprise a plurality of fourth devices 140 to control the signalling, PDU session and so on. In the specific example of FIG. 1, the fourth devices 140-1 and 140-2 are connected to the second device 120-1, and the fourth devices 140-3 and 140-4 are connected to the second device 120-2. Further, the fourth device 140 may be either an AMF or SMF. As one specific embodiment, the fourth devices 140-1 and 140-3 may be AMFs, and the fourth devices 140-2 and 140-4 may be SMFs.

In some example embodiments, there may be more than one slice deployed in the communication environment 100, and each slice may be identified by respective S-NSSAI.

Further, in some example embodiments, for one slice/S-NSSAI, a global maximum allowed number value (i.e., a maximum number of UEs and PDU sessions) is configured for NSAC. In some example embodiments, the first device 110 performs the NSAC for each slice/S-NSSAI based on the global maximum allowed number value, and allocates corresponding quotas to the serving areas.

In some example embodiments, a hierarchical NSACF architecture is supported in the communication environment 100. Specifically, for a slice/S-NSSAI, one NSACF acting as primary NSACF is introduced, such as the first device 110 in FIG. 1. Each of the other NSACFs (such as the second device 120 in FIG. 1) serves one service area. The Primary NSACF enables a centralized management of the global maximum allowed number value. As one specific example embodiment, the service level agreement (SLA) attribute (i.e., the global maximum number value valid across service areas) is only configured at the primary NSACF, and is shared among different service area(s)/VPLMN(s).

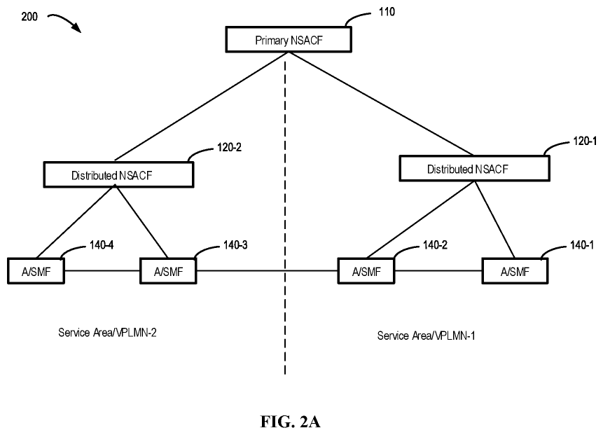

For better understanding, reference is now made to FIG. 2A, which illustrates a hierarchical NSACF architecture 200 according to some example embodiments.

In some example embodiments, a distributed NSACF is deployed on a service area basis, which may be one NSACF instance or one NSACF Set. Further, each distributed NSACF performs maximum number of registered user equipment or established PDU sessions control independently. In this event, a UE registration or PDU session establishment may be rejected by the network due to the local maximum number of UE/PDU session is reached at the current serving NSACF even the maximum number may still be available at other NSACFs.

For better understanding, reference is now made to FIGS. 2B to 2D, where FIG. 2B illustrates a signaling chart 220 for NSAC check of the maximum number of UEs according to some example embodiments, FIG. 2C illustrates a signaling chart 240 for NSAC check of the maximum number of PDU sessions according to some example embodiments, and FIG. 2D illustrates a signaling chart 260 for redistribution of local maximum number according to some example embodiments.

It is to be understood that the number of devices and their connections shown in FIG. 1 are only for the purpose of illustration without suggesting any limitation. In the other example embodiments, the communication environment 100 may include any suitable number of devices configured to implementing example embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution for security countermeasure for distributed NSAC.

In this solution, a device (such as, a primary NSACF or an analytics device) may obtain information associated with more accurate number(s) of user equipment or PDU sessions specific to a slice or S-NSSAI. With such information, the compromised/malicious distributed NSACF(s)/AMF(s)/SMF(s) may be identified.

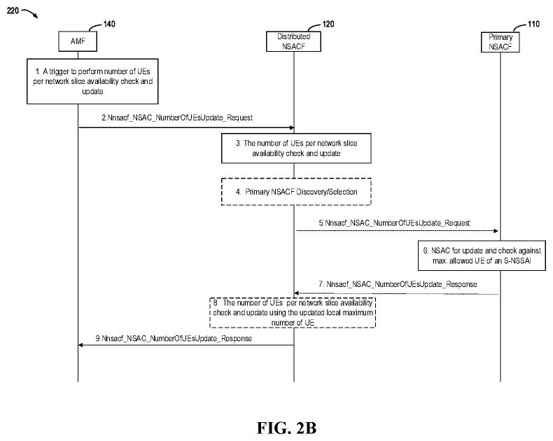

Reference is now made to FIG. 3, which shows a signaling chart 300 for communication according to some example embodiments of the present disclosure. As shown in FIG. 3, the signaling chart 300 involves a first device 110, a second device 120, third device(s) 130, fourth device(s) 140 and a fifth device 150.

Further, in the specific example of FIG. 3, the NSAC procedure relates to at least of a number of UEs and a number of PDU sessions.

For the purpose of discussion, reference is made to FIG. 1 to describe the signaling chart 300. Merely for better understand, in the following example embodiments, the first device 110 is described as a primary admission control device, the second device 120 is described as a distributed admission control device, the third device 130 is described as a user data management device, the fifth device 150 is described as a management device (such as, OAM). It is to be understood that in the other embodiments, the first device 110 to the fifth device 150 may be any suitable device type. The present disclosure is not limited in this regard.

In the specific embodiment of FIG. 3, the second device 120 may correspond a serving area/VPLM, and may be served by one or more slices. Further, one or more fourth devices 140 (such as, AMF(s) and SMF(s)) may be located in the serving area corresponding to the second device 120.

In some example embodiments, one or more third devices 130 are deployed in the communication environment 100. Each third device 130 may be responsible for maintaining user data for one or more user groups, one or more serving areas/VPLMNs, one or more subnetworks, and so on. In a nutshell, the total users/user data may be divided to be maintained by the one or more third devices 130 in any suitable manner. The present disclosure is not limited in this regard.

In some example embodiments, at least part of the one or more third devices 130 may be accessed by the fourth device(s) 140 according to the network deployment and configuration.

In some example embodiments, the fist device 110 and the one or more third devices 130 are located in the central area of the communication environment 100, and the first device 110 may access all of the one or more third devices 130.

In some example embodiments, the third device 130 may provide a more accurate number of UEs or PDU sessions by interacting with the fourth device(s) 140 as discussed with reference to FIG. 3.

As illustrated in FIG. 3, after receiving a registration request from a user equipment, in response to a complete of the registration for the user equipment, the fourth device 140 transmits 305 a fifth message to the third device 130. In some example embodiments, the fifth message comprises information on one or more allowed S-NSSAI. With such information, the third device 130 may establish association(s) among the fourth device 140, the registered user equipment with the allowed S-NSSAI. Additionally, in some example embodiments, the fourth device 140 handling the registration request may be an AMF.

In one specific example embodiment, the fourth device 140 (such as, an AMF) receives a registration request from the user equipment. Upon a completion of primary authentication and authorization for the user equipment, the fourth device 140 transmits a message of Nudm_UECM_Registration to the third device 130 to inform about the allowed slices list, for example, the registration message comprises one or more allowed S-NSSAI.

Theoretically, a malicious AMF may fake message of Nudm _UECM_Registration. However, as feature of linking increased home control to subsequent procedures, this kind of threat can be addressed. Another possibility is that the AMF may fake the S-NSSAI to the S-NSSAI it intends to attack. However, as the total number of registered user equipment cannot be faked, and the S-NSSAI should be part of subscribed S-NSSAIs of the user equipment in any case, it's difficult to the malicious AMF to realize DOS attack with general signaling, such as, message of Nudm_UECM_Registration without involving huge number of real user equipment.

In view of the above, the third device 130 may have a capability to provide a more accurate number of (registered) user equipment.

In some example embodiments, the third device 130 also may communicate with the fourth device 140 (such as, an SMF) to obtain a more accurate number of PDU session. As illustrated in FIF. 3, after creating PDU sessions for a user equipment on a slice, the fourth device 140 transmits 310 a message of Nudm_UECM_Registration to the third device 130 to register the PDU session, where the message of Nudm_UECM_Registration comprises an allowed S-NSSAI. With such information, the third device 130 may establish association(s) among the fourth device 140, the established PDU session with the S-NSSAI.

Theoretically, a malicious SMF may fake message of Nudm_UECM_Registration. However, as the total number of registered user equipment cannot be faked, the number of PDU sessions for one user equipment is restricted. Thus, similar to AMF, it's difficult for the malicious SMF to realize DOS attack with general signaling (such as Nudm_UECM_Registration) without involving huge number of real user equipment.

In view of the above, the third device 130 also may have a capability to provide a more accurate number of PDU sessions. Further, with the enhance features, the third device 130 may generate a report for the number of registered user equipment or PDU sessions per network slice for a specific VPLMN/serving area/AMF(s)/SMF(s).

In view of the enhancement for the third device 130, an enhanced secure countermeasure for NSAC may be achieved as discussed below.

In some example embodiments, the second device 120 transmits 310 a first message for updating one or more admission numbers of user equipment or PDU sessions to the first device 110. Alternatively, in some example embodiments, the second device 120 transmits 310 a first message for reporting one or more admission numbers of user equipment or PDU sessions to the first device 110. In particular, each admission number is associated with the serving area/VPLMN corresponding to the second device 130 and is specific to a specific S-NSSAI.

In some example embodiments, transmitting the first message is triggered by one or more specific events. One example event is the number of UEs or PDU sessions is reaching/have been reached the maximum admission number allocated to the corresponding serving area (such as, the local maximum number of UEs or PDU sessions). Another example of is the number of UEs or PDU sessions exceeds a pre-defined threshold number. A further event is the increasing rate of user equipment or PDU sessions exceeds a pre-defined threshold rate.

It should be appreciated that the above example events are given for the purpose of illustration without suggesting any limitations. In some other embodiments, the transmission of the first message may be triggered by any suitable event. Further, the above events and the other suitable events may be used either separately or in combination. The present disclosure is not limited in this regard.

Alternatively, in some other embodiments, the first message is transmitted periodically. The periodicity may either be a default parameter stipulated by wireless standards (such as, 3GPP), or be configured by a network device or the network operator.

In summary, the present discourse is not limited with regard to how to transmit the first message.

In some example embodiments, the admission number comprised in the first message indicates a maximum admission number allocated to the serving area. In this event, the first device 110 may be informed that the number of UEs or PDU sessions is reaching/has been reached the maximum admission number allocated to the serving area.

Alternatively, or in addition, the admission number comprised in the first message indicates a current admission number determined by the second device 120. In this way, the first device may understand the operation information of the serving area.

As one specific example embodiment, the second device 120 (a distributed NSACF in a VPLMN or specific serving area) transmits message of Nnsacf_NSAC_NumberOfUEsUpdate_Request or Nnsacf_NSAC_NumberOfPDUsUpdate_Request to the first device 110 (a primary NSACF), which implies that the local maximum or the pre-configured threshold number of user equipment/PDU session for triggering the reporting is reaching/has been reached.

As discussed above, the admission number determined by the second device 120 may be faked or incorrect. Thus, as illustrated in the FIG. 3, after receiving the first message, the first device 110 may determine 390 a first number of UEs or PDU sessions specific to the slice or the S-NSSAI. In particular, the first number is counted by at least one third device 130.

As discussed above, the number of UEs or PDU session counted by the at least one third device 130 is more accurate. Thus, the admission number indicated by the first message may be verified with the first number.

Next, the first device may perform 395 an admission control procedure based at least in part on the first number. Specifically, in some example embodiments, the first device 110 compares 355 the first number with the admission control number (such as, the local maximum number comprised in the message of Nnsacf_NSAC_NumberOfUEsUpdate_Request or Nnsacf_NSAC_NumberOfPDUsUpdate_Request) to determine whether the first number is matched with the admission control number.

In some example embodiments, if the difference between the first number and the admission control number is smaller than a threshold difference, it is determined that first number is matched with the admission control number, else it is determined that first number is mismatched with the admission control number.

Next, in some example embodiments, if the first number is matched with the admission control number, the first device 110 performs 360 a NSAC procedure based at least in part on the first message. As one specific example embodiment, the second device 120 (i.e., a distributed NSACF) transmits a message of Nnsacf_NSAC_NumberUpdate_Request (i.e., the first message) to the first device 110 (i.e, a primary NSACF). The first message includes the S-NSSAI, requested local maximum user equipment/PDU session number, i.e. increasing the local maximum user equipment/PDU session number/admission number. If the first number is matched with the admission control number. The first device 110 checks the global maximum user equipment/PDU session number and determines whether to accept or reject the requested the local maximum user equipment/PDU session number, i.e. whether the update of the local maximum user equipment/PDU session number of the second device 120 is accepted. If the first device 110 has no more available allowance, the first device 110 may indicate to the second device 120 to reject any new increase request. Else, the first device 110 may accept the requested local maximum user equipment/PDU session number.

Then, the first device 110 returns a response message of Nnsacf_NSAC_NumberUpdate_Response. The response message may include a new allocated local maximum PDU session number, or it may return indication to reject any further new user registration/PDU sessions with a cause code.

Alternatively, in some example embodiments, if the first number is mismatched with the admission control number, the first device may determine that a potential anomaly of the second device 120 or the serving area is occurred.

In this event, the first device 110 may handle such potential anomaly. In some example embodiments, the first device 110 may stop 365 the NSAC procedure for the first message, as the second device 120 may be a compromised/malicious device.

Alternatively, or in addition, in some example embodiments, the first device 110 may adjust the admission control number according to the first number, as compared with the admission control number indicated by the first message, the first number counted by the third device(s) 130 is more accurate.

Alternatively, or in addition, in some example embodiments, the first device 110 may transmit 370 a fourth message to a fifth device 150, where the fourth message may indicate that an anomaly has occurred at the second device 120 or in the serving area and the fifth device 150 may be a management device (such as, OAM). With the fourth message, the fifth device 150 may trigger 380 a security procedure to handle such anomaly, such as, re-deploy the second device 120 or other related network function/node.

In some example embodiments, the fourth message may indicate at least one of the following: an identity of the second device 120 (such as, an NSACF identity), or an identity of the serving area/VPLMN corresponding to the second device 120.

Additionally, in some example embodiments, the first device 110 may transmit 375 a response message for the first message, where the response message may indicate whether the requested update indicated by the first message is successful (accepted) or failed (rejected). As one specific example embodiment, the first device 110 returns a response message of Nnsacf_NSAC_Number Update_Response, where the response message may include a new allocated local maximum PDU session number, or it may return indication to reject any further new user registration/PDU sessions with a cause code.

In view of verification the admission control requires additional processes, the verification operation may be configured to be performed conditionally. In some example embodiments, prior to determining the first number (i.e., performing the verification), the first device 110 may determine whether it is needed to verify the admission number according to a pre-configured policy. The pre-configured policy may be associated with a plurality of factors. One example factor is a threat surface of the second device 120. Another example factor is the S-NSSAI. A further example is an identity of PLMN corresponding to the first device 110. The other example factors, include but are not limited to, an identity of VPLMN corresponding to the second device 120, a pre-configured threshold number of UEs or PDU sessions, and a security control policy of the serving area.

In one specific example embodiment, the verification may be triggered based on a pre-configured threshold configuration for each second device 120 (i.e., the serving area). For example, if the number of UEs or PDU session exceeds the pre-configured threshold but does not reach the maximum value, the first device 110 may trigger to verify the admission number. Similarly, when the number of UEs or PDU session drops below a further threshold number, the first device 110 also may trigger to verify the admission number.

It should be appreciated that the above example factors are given for the purpose of illustration without suggesting any limitations. In some other embodiments, the pre-configured policy may be associated with any suitable factors. Further, the above factors and the other suitable factors may be used either separately or in combination. The present disclosure is not limited in this regard.

As the pre-configured policy is introduced, in some example embodiments, the verification procedure may be skipped. In some example embodiments, if it is determined that it is not needed to verify the admission number, the first device 110 performs the NSAC procedure based at least in part on the first message as discussed above. In this way, whether to verify the admission number may be performed more flexible. For example, the verification procedure is only performed on the high-risk serving area, or the verification procedure is performed only in case that the reported admission number is higher than a pre-defined threshold value.

In the following, detailed processes about how to determine the first number will be discussed.

Because the fourth device(s) 140 located in the serving area may access more than one third device 130 during the procedure of UE registration and PDU session establishment, the first device 110 thus needs to communicate with more than one third device 130 to obtain the first number.

As illustrated in FIG. 3, the first device 110 transmits 335 a second message to each related third device 130. In particular, the second message is used for requesting a second number of UEs or PDU sessions associated with the serving area and is specific to the slice or the S-NSSAI.

In some example embodiments, prior to transmitting the second message to each related third device 130, the first device 110 determines 330 the related third device(s) 130 first. In some example embodiments, the first device 110 determines the related third device(s) 130 by scanning all accessible third devices 130. Alternatively, in some other embodiments, the first device 110 determines the related third device(s) 130 by performing a discovery procedure of third device 130 according to a pre-configured rule. Further, the pre-configured rule may be stored locally or in the network repository function (NRF).

In some example embodiments, in order to contact the related third device(s) 130, the NRF discovery service is enhanced to return individual instances of the third device 130 that hold all the subscribers. For example, if the third device 130-1 is configured to support the subscribers in the first area, and the third device 130-2 is configured to support the subscribers in the second area, the NRF would return both the third devices 130-1 and the third device 130-2. Alternatively, the NRF may return all the instances of the third device 130 and the first device 110 may determine the groups of the third device 130 based on network function profile of the third device 130.

In some example embodiments, the second message may comprise parameters indicating the requirement associated with the second number. One example parameter is the S-NSSAI. Another example parameter is an identity of the serving area or an identity of VPLMN associated with the second device 120. A further parameter is at least one identity of at least one fourth device 140 being located in the serving area, such as, a list of AMF/SMF identities.

In this way, the first device 110 may request each of the related third device 130 to obtain the number of UEs registered in a specific VPLMN or AMFs/SMFs of HPLMN for the specific slice/S-NSSAI, or the number of PDU sessions established in a specific VPLMN or AMFs/SMFs of HPLMN for the specific slice/S-NSSAI.

Additionally, in view of the AMF/SMF identities are certain to be identifiable for the related third device 130, before transmitting second message, the first device 110 may determine 325 the at least one identity of the at least one fourth device 140 in the serving area first. In some example embodiments, the first device 110 determines the at least one identity of the at least one fourth device according to a first mapping of the second device 120 and the at least fourth device 140. Alternatively, in some example embodiments, the first device 110 determines the at least one identity of the at least one fourth device according to a second mapping of the serving area and the at least fourth device 140.

In some example embodiments, the first/second mapping is pre-configured at the first device 110. Alternatively, in some other example embodiments, the fourth devices 140 update the user equipment/PDU session count to the second device 120, and the second device 120 communicates information on the fourth device 140 to the first device 110.

As discussed above, the third device 130 has a capability to provide a more accurate number of UEs or PDU session. Further, the third device 130 also has established association(s) among the fourth device 140, the registered user equipment, the allowed S-NSSAI and/or the established PDU session. Thus, after receiving the second message, the third device may generate 340 a third message indicating the requested second number.

Additionally, the second number may be reported at any suitable granularity. In some example embodiments, the second number is specific to the second device 120. Alternatively, in some example embodiments, the second number is specific to the serving area. Alternatively, in some example embodiments, the second number is specific to at least one fourth device 140 being located in the serving area. In a nutshell, the second number may be counted flexibly, and the present disclosure is not limited in this regard.

Next, the third device 130 transmits 345 the third message to the first device 110. In this way, the first device 110 may obtain the second number from each of the related third device 130. In some example embodiments, the first device 110 determines the first number by consolidating 350 at least one second number received from the at least one related third device 130.

According to the above procedure, the admission number reported by the second device 120 may be verified by the first device 110. As a result, the compromised/malicious second device 120/fourth device 140 may be identified timely.

In addition, according to some example embodiments of the present disclosure, an analytics device (such as, AI/ML-based network function) also may identify the anomaly of the second device 120/serving area/fourth device 140.

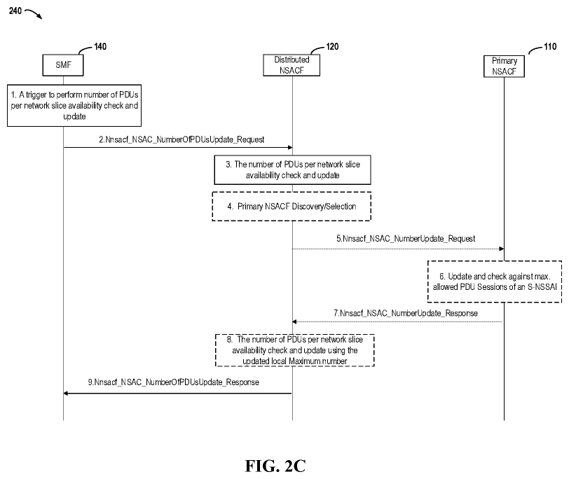

Reference is now made to FIG. 4, which shows a signaling chart 400 for communication according to some example embodiments of the present disclosure. As shown in FIG. 4, the signaling chart 400 involves a sixth device 160, a fifth device 150 and a plurality of devices.

For the purpose of discussion, reference is made to FIG. 1 to describe the signaling chart 400. Merely for better understand, in the following example embodiments, the fifth device 150 is described as a management device (such as, OAM), and the sixth device 160 is described as an analytics device (such as, NWDAF or MDAS producer).

In operation, the sixth device 160 collects 410 information associated with a plurality of numbers of user equipment or PDU sessions specific to a slice or S-NSSAI from a plurality of devices.

In some example embodiments, the plurality of devices comprise but are not limited to: a primary admission control device (such as, the first device 110 in FIG. 1), at least one distributed admission control device (such as, the second device 120 in FIG. 1), at least one control device (such as, the fourth device 140 in FIG. 1), at least one user data management device (such as, the first device 130 in FIG. 1), or at least one analytics device. That is, the sixth device 160 may collect the related information from any suitable device. The present disclosure is not limited in this regard.

Additionally, in some example embodiments, the collected information may be a number of UEs or PDU sessions determined by a respective device. Alternatively, or in addition, in some example embodiments, the collected information may be a trace (or log) recorded on a respective device. Alternatively, or in addition, in some example embodiments, the collected information may be a load or congestion information/report generated by a respective device. That is, the collected information may be represented as any suitable forms. The present disclosure is not limited in this regard.

Based on the collected information, the sixth device 160 may determines 420 an operation status of a second device 120 (i.e., a distributed admission control device).

As one specific example embodiment, with the collected information, the sixth device 160 may determine the admission number, the second number and/or the first number. Then the sixth device 160 may determine the operation status accordingly as discussed above.

Additionally, if the operation status is determined to be abnormal, the sixth device 160 also may transmit 430 a fourth message to the fifth device (or the first device 110, not shown in FIG. 4), where the fourth message indicates that an anomaly has occurred at the second device 120 or in the serving area.

In one specific example embodiment, the NWDAF/MDAF (such as, the sixth device 160) supports new analytics of malicious NSACF detection. The NWDAF/MDAF of the HPLMN monitors the trends of quota for each distributed NSACF (such as, the second device 120) by collecting data from primary NSACF (such as, the first device 110).

Further, in the specific example embodiment, the NWDAF/MDAF also may collect a more accurate number of UEs or PDU sessions counted by the UDMs and/or additional data (e.g. information/log/trace from AMF(s)/SMF(s), load information of the slice, congestion report of the slice and so on). Then, the NWDAF/MDAF compares the quota with a more accurate number of UEs or PDU sessions. If the malicious/compromised distributed NSACF is detected, the NWDAF/MDAF may generate an analytics report (such as, the fourth message) to alarm/report the potential malicious/compromised distributed NSACF. Alternatively, or in addition, if the malicious/compromised distributed NSACF is detected, the NWDAF/MDAF also may trigger to reduce the quota for the distributed NSACF, or trigger to re-deploy the distributed NSACF and other network functions in the same serving area or VPLMN.

In this way, the anomaly of the second device 120 or the serving area may be identified and handled timely.

### Example Methods

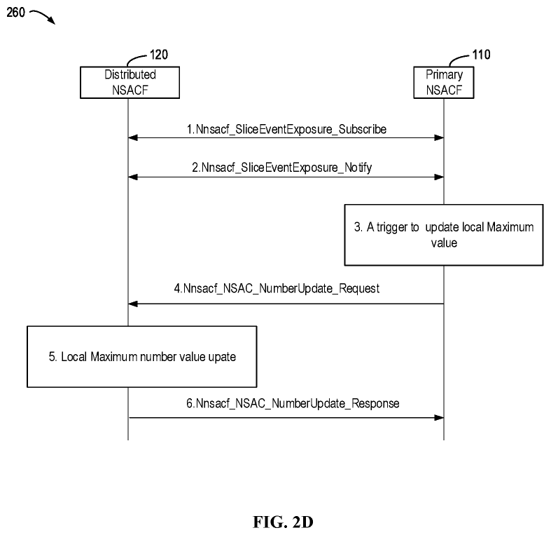

FIG. 5 shows a flowchart of an example method 500 implemented at a first device 110 in accordance with some example embodiments of the present disclosure. For the purpose of discussion, the method 500 will be described from the perspective of the first device 110 in FIG. 1.

At block 510, the first device 110 receives, from a second device 120, a first message for updating or reporting an admission number of UEs or PDU sessions associated with a serving area corresponding to the second device 120, the admission number being specific to a slice or S-NSSAI.

At block 520, the first device 110 determines, a first number of UEs or PDU sessions specific to the slice or the S-NSSAI counted by at least one third device 130, such that the admission number is verified with the first number.

At block 530, the first device 110 performs an admission control procedure based at least in part on the first number.

In some example embodiments, the admission number indicates one of the following: a maximum admission number allocated to the serving area, or a current admission number determined by the second device 120.

In some example embodiments, further comprising: prior to determining the first number, determining whether it is needed to verify the admission number according to a pre-configured policy associated with at least one of the following: a threat surface of the second device 120, the S-NSSAI, an identity of PLMN corresponding to the first device 110, the serving area, an identity of VPLMN corresponding to the second device 120, or a security control policy of the serving area.

In some example embodiments, further comprising: in accordance with a determination that it is not needed to verify the admission number, performing, based at least in part on the first message, an NSAC procedure.

In some example embodiments, determining the first number comprises: transmitting, to each of the at least one third device 130, a second message for requesting a second number of UEs or PDU sessions associated with the serving area, the second number being counted by a respective third device 130 of the at least one third device 130 and being specific to the slice or the S-NSSAI; receiving, from each of the at least one third device 130, a third message indicating the second number; and determining the first number by consolidating at least one second number received from the at least one third device 130.

In some example embodiments, the second message comprises at least one of the following: the S-NSSAI, an identity of the serving area, an identity of visited PLMN (VPLMN) associated with the second device 120, or at least one identity of at least one fourth device 140 being located in the serving area, each of the at least one fourth device 140 being a control device.

In some example embodiments, the first device 110 determines the at least one identity of the at least one fourth device 140 according to a mapping of one of the following: a first mapping of the second device 120 and the at least fourth device 140, or a second mapping of the serving area and the at least fourth device 140.

In some example embodiments, the second number is specific to one of the following: the second device 120, the serving area, or at least one fourth device 140 being located in the serving area, each of the at least one fourth device 140 being a control device.

In some example embodiments, prior to transmitting the second message to each of the at least one third device 130, the first device 110 determines the at least one third device 130 by one of the following: scanning all accessible third device 130, or performing a discovery procedure of third device 130 according to a pre-configured rule.

In some example embodiments, performing the admission control procedure based at least in part on the first number comprises: comparing the first number with the admission control number; if the first number is matched with the admission control number, performing, based at least in part on the first message, an NSAC procedure; and if the first number is mismatched with the admission control number, performing at least one of the following: stopping the NSAC procedure; adjusting the admission control number according to the first number; or transmitting a fourth message to a fifth device 150, the fourth message indicating that an anomaly has occurred at the second device 120 or in the serving area.

In some example embodiments, the fifth device 150 is a management device.

In some example embodiments, the first device 110 is a primary admission control device, the second device 120 is a distributed admission control device, and the third device 130 a user data management device.

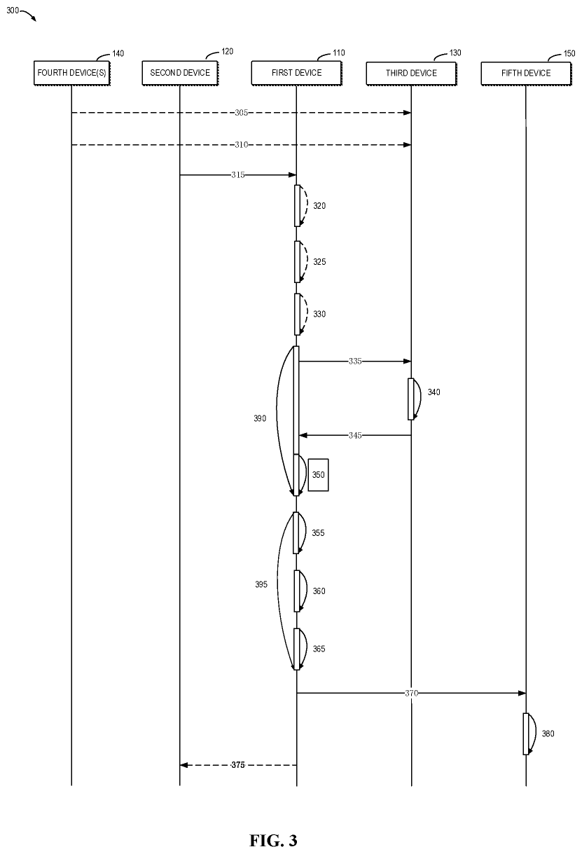

FIG. 6 shows a flowchart of an example method 600 implemented at a third device 120 in accordance with some example embodiments of the present disclosure. For the purpose of discussion, the method 600 will be described from the perspective of the third device 130 in FIG. 1.

At block 610, the third device 130 receives, from a first device 110, a second message for requesting a second number of UEs or PDU sessions associated with a serving area corresponding to a second device 120, the second number being counted by the third device 130 and being specific to a slice or S-NSSAI.

At block 620, the third device 130 generates a third message indicating the second number.

At block 630, the third device 130 transmits the third message to the second device 120.

In some example embodiments, the second message comprises at least one of the following: the-NSSAI, an identity of the serving area, an identity of VPLMN associated with the second device 120, or at least one identity of at least one fourth device 140 being located in the serving area, each of the at least one fourth device 140 being a control device.

In some example embodiments, the second number is specific to one of the following: the second device 120, the serving area, at least one fourth device 140 being located in the serving area, each of the at least one fourth device 140 being a control device.

In some example embodiments, further comprising: receiving, from a fourth device 140, a fifth message comprising information on one or more allowed S-NSSAI, the fifth message being transmitted by the fourth device 140 in response to a complete of registration for user equipment, the fourth device 140 being an AMF.

In some example embodiments, the first device 110 is a primary admission control device or an analytics device, the second device 120 is a distributed admission control device, and the third device 130 a user data management device.

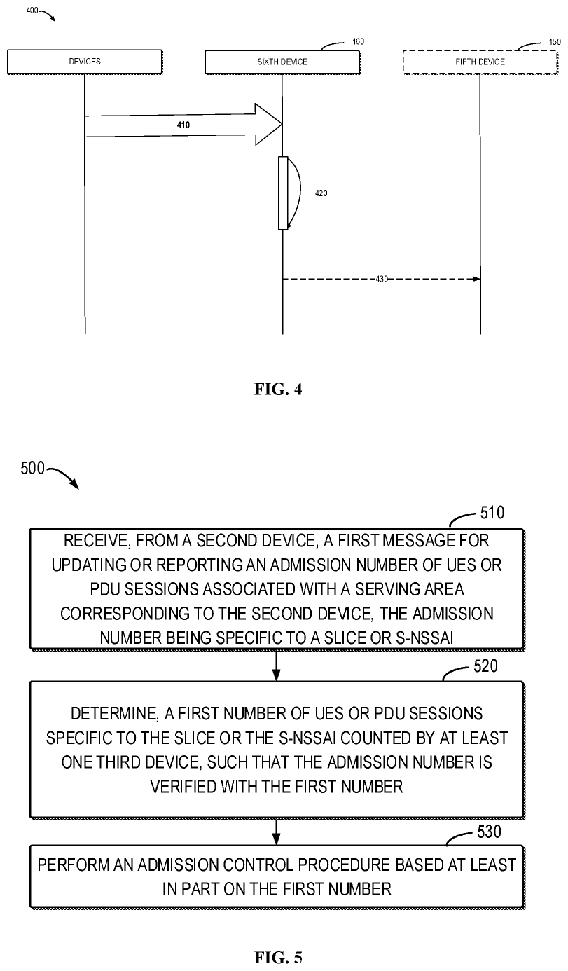

FIG. 7 shows a flowchart of an example method 700 implemented at a fourth device 140 in accordance with some example embodiments of the present disclosure. For the purpose of discussion, the method 700 will be described from the perspective of the fourth device 140 in FIG. 1.

At block 710, the fourth device 140 receives from user equipment, a registration request.

At block 720, in response to a complete of registration for the user equipment, the fourth device 140 transmits, to a third device 130, a fifth message comprising information on one or more allowed S-NSSAI.

In some example embodiments, the fourth device 140 is an AMF, and the third device 130 is a user data management device.

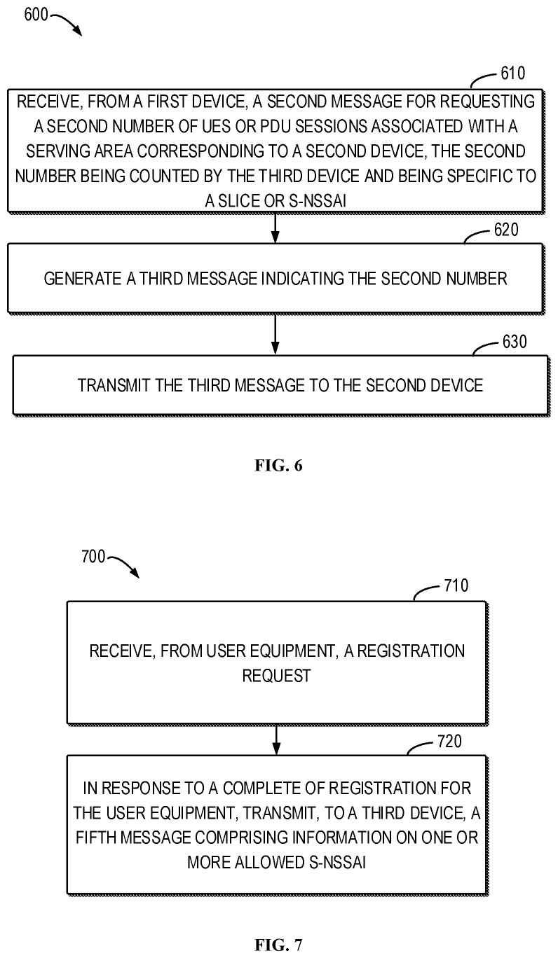

FIG. 8 shows a flowchart of an example method 800 implemented at a fifth device 150 in accordance with some example embodiments of the present disclosure. For the purpose of discussion, the method 800 will be described from the perspective of the fifth device 150 in FIG. 1.

At block 810, the fifth device 150 receives a fourth message from a first device 110, the fourth message indicating that an anomaly has occurred at a second device 120 or a serving area where the second device 120 is located, the second device 120 being a distributed admission control device.

At block 820, the fifth device 150 triggers a security procedure to handle the anomaly.

In some example embodiments, the first device 110 is a primary admission control device or an analytics device, and the fifth device 150 is a management device.

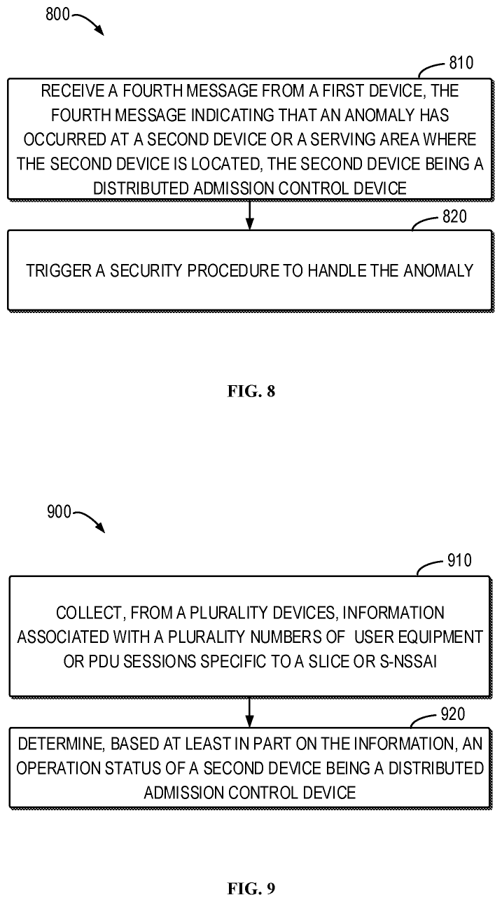

FIG. 9 shows a flowchart of an example method 900 implemented at a sixth device 160 in accordance with some example embodiments of the present disclosure. For the purpose of discussion, the method 900 will be described from the perspective of the sixth device 160 in FIG. 1.

At block 910, the sixth device 160 collects, from a plurality of devices, information associated with a plurality of numbers of user equipment or PDU sessions specific to a slice or S-NSSAI.

At block 920, the sixth device 160 determines, based at least in part on the information, an operation status of a second device 120 being a distributed admission control device.

In some example embodiments, the information associated with the plurality of numbers comprises at least one of the following: a number of UEs or PDU sessions determined by a respective device of the plurality devices, a trace recorded on a respective device of the plurality devices, or a load or congestion information report generated by a respective device of the plurality devices.

In some example embodiments, further comprising: if the operation status is determined to be abnormal, transmitting a fourth message to a fifth device 150, the fourth message indicating that an anomaly has occurred at the second device 120 or in the serving area.

In some example embodiments, the sixth device 160 is an analytics device, and the plurality of devices comprises at least one of the following: a primary admission control device, at least one distributed admission control device, at least one control device, at least one user data management device, or at least one analytics device.

### Example Apparatus, Device and Medium

In some example embodiments, a first apparatus capable of performing any of the method 500 (for example, the first device 110 in FIG. 1) may comprise means for performing the respective operations of the method 500. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a second apparatus, a first message for updating or reporting an admission number of UEs or PDU sessions associated with a serving area corresponding to the second apparatus, the admission number being specific to a slice or S-NSSAI; and means for determining, a first number of UEs or PDU sessions specific to the slice or the S-NSSAI counted by at least one third apparatus, such that the admission number is verified with the first number; and means for performing an admission control procedure based at least in part on the first number.

In some example embodiments, the admission number indicates one of the following: a maximum admission number allocated to the serving area, or a current admission number determined by the second apparatus.

In some example embodiments, further comprising: means for prior to determining the first number, determining whether it is needed to verify the admission number according to a pre-configured policy associated with at least one of the following: a threat surface of the second apparatus, the S-NSSAI, an identity of PLMN corresponding to the first apparatus, the serving area, an identity of VPLMN corresponding to the second apparatus, or a security control policy of the serving area.

In some example embodiments, further comprising: means for in accordance with a determination that it is not needed to verify the admission number, performing, based at least in part on the first message, an NSAC procedure.

In some example embodiments, means for determining the first number comprises: means for transmitting, to each of the at least one third apparatus, a second message for requesting a second number of UEs or PDU sessions associated with the serving area, the second number being counted by a respective third apparatus of the at least one third apparatus and being specific to the slice or the S-NSSAI; means for receiving, from each of the at least one third apparatus, a third message indicating the second number; and means for determining the first number by consolidating at least one second number received from the at least one third apparatus.

In some example embodiments, the second message comprises at least one of the following: the S-NSSAI, an identity of the serving area, an identity of VPLMN associated with the second apparatus, or at least one identity of at least one fourth apparatus being located in the serving area, each of the at least one fourth apparatus being a control apparatus.

In some example embodiments, further comprising: means for determining the at least one identity of the at least one fourth apparatus according to a mapping of one of the following: a first mapping of the second apparatus and the at least fourth apparatus, or a second mapping of the serving area and the at least fourth apparatus.

In some example embodiments, the second number is specific to one of the following: the second apparatus, the serving area, or at least one fourth apparatus being located in the serving area, each of the at least one fourth apparatus being a control apparatus.

In some example embodiments, further comprising: means for prior to transmitting the second message to each of the at least one third apparatus, determining the at least one third apparatus by one of the following: means for scanning all accessible third apparatuses, or means for performing a discovery procedure of third apparatus according to a pre-configured rule.

In some example embodiments, means for performing the admission control procedure based at least in part on the first number comprises: means for comparing the first number with the admission control number; means for if the first number is matched with the admission control number, performing, based at least in part on the first message, an NSAC procedure; and means for if the first number is mismatched with the admission control number, performing at least one of the following: means for stopping the NSAC procedure; means for adjusting the admission control number according to the first number; or means for transmitting a fourth message to a fifth apparatus, the fourth message indicating that an anomaly has occurred at the second apparatus or in the serving area.

In some example embodiments, the fifth apparatus is a management apparatus.

In some example embodiments, the first apparatus is a primary admission control apparatus, the second apparatus is a distributed admission control apparatus, and the third apparatus a user data management apparatus.

In some example embodiments, the first apparatus further comprises means for performing other operations in some example embodiments of the method 500 or the first device 110. In some example embodiments, the means comprises at least one processor; and at least one memory storing instructions that, when executed by the at least one processor, cause the performance of the first apparatus.

In some example embodiments, a third apparatus capable of performing any of the method 600 (for example, the third device 130 in FIG. 1 may comprise means for performing the respective operations of the method 600. The means may be implemented in any suitable form. For example, the means may be implemented in a circuitry or software module. The third apparatus may be implemented as or included in the third device 130 in FIG. 1.

In some example embodiments, the third apparatus comprises means for receiving, from a first apparatus, a second message for requesting a second number of UEs or PDU sessions associated with a serving area corresponding to a second apparatus, the second number being counted by the third apparatus and being specific to a slice or S-NSSAI; means for generating a third message indicating the second number; and means for transmitting the third message to the second apparatus.

In some example embodiments, the second message comprises at least one of the following: the-NSSAI, an identity of the serving area, an identity of VPLMN associated with the second apparatus, or at least one identity of at least one fourth apparatus being located in the serving area, each of the at least one fourth apparatus being a control apparatus.

In some example embodiments, the second number is specific to one of the following: the second apparatus, the serving area, at least one fourth apparatus being located in the serving area, each of the at least one fourth apparatus being a control apparatus.

In some example embodiments, the third apparatus further comprises: means for receiving, from a fourth apparatus, a fifth message comprising information on one or more allowed S-NSSAI, the fifth message being transmitted by the fourth apparatus in response to a complete of registration for user equipment, the fourth apparatus being an AMF.

In some example embodiments, the first apparatus is a primary admission control apparatus or an analytics apparatus, the second apparatus is a distributed admission control apparatus, and the third apparatus a user data management apparatus.

In some example embodiments, the third apparatus further comprises means for performing other operations in some example embodiments of the method 600 or the third device 130. In some example embodiments, the means comprises at least one processor; and at least one memory storing instructions that, when executed by the at least one processor, cause the performance of the third apparatus.

In some example embodiments, a fourth apparatus capable of performing any of the method 700 (for example, the fourth device 140 in FIG. 1) may comprise means for performing the respective operations of the method 700. The means may be implemented in any suitable form. For example, the means may be implemented in a circuitry or software module. The fourth apparatus may be implemented as or included in the fourth device 140 in FIG. 1.

In some example embodiments, the fourth apparatus comprises means for receiving, from user equipment, a registration request; and means for in response to a complete of registration for the user equipment, transmitting, to a third apparatus, a fifth message comprising information on one or more allowed S-NSSAI.

In some example embodiments, the fourth apparatus is an AMF, and the third apparatus is a user data management apparatus.

In some example embodiments, the fourth apparatus further comprises means for performing other operations in some example embodiments of the method 700 or the fourth device 140. In some example embodiments, the means comprises at least one processor; and at least one memory storing instructions that, when executed by the at least one processor, cause the performance of the third apparatus.

In some example embodiments, a fifth apparatus capable of performing any of the method 800 (for example, the fifth device 150 in FIG. 1) may comprise means for performing the respective operations of the method 800. The means may be implemented in any suitable form. For example, the means may be implemented in a circuitry or software module. The fifth apparatus may be implemented as or included in the fifth device 150 in FIG. 1.

In some example embodiments, the fifth apparatus comprises means for receiving a fourth message from a first apparatus, the fourth message indicating that an anomaly has occurred at a second apparatus or a serving area where the second apparatus is located, the second apparatus being a distributed admission control apparatus; and means for triggering a security procedure to handle the anomaly.

In some example embodiments, the first apparatus is a primary admission control apparatus or an analytics apparatus, and the fifth apparatus is a management apparatus.

In some example embodiments, the fifth apparatus further comprises means for performing other operations in some example embodiments of the method 800 or the fifth device 150. In some example embodiments, the means comprises at least one processor; and at least one memory storing instructions that, when executed by the at least one processor, cause the performance of the fourth apparatus.

In some example embodiments, a sixth apparatus capable of performing any of the method 900 (for example, the sixth device 160 in FIG. 1) may comprise means for performing the respective operations of the method 900. The means may be implemented in any suitable form. For example, the means may be implemented in a circuitry or software module. The sixth apparatus may be implemented as or included in the sixth device 160 in FIG. 1.

In some example embodiments, the sixth apparatus comprises means for collecting, from a plurality apparatus, information associated with a plurality of numbers of user equipment or PDU sessions specific to a slice or S-NSSAI; and means for determining, based at least in part on the information, an operation status of a second apparatus being a distributed admission control apparatus.

In some example embodiments, the information associated with the plurality of numbers comprises at least one of the following: a number of UEs or PDU sessions determined by a respective apparatus of the plurality of apparatuses, a trace recorded on a respective apparatus of the plurality of apparatuses, or a load or congestion information report generated by a respective apparatus of the plurality of apparatuses.

In some example embodiments, the sixth apparatus further comprises: means for if the operation status is determined to be abnormal, transmitting a fourth message to a fifth apparatus, the fourth message indicating that an anomaly has occurred at the second apparatus or in the serving area.

In some example embodiments, the sixth apparatus is an analytics apparatus, and the plurality of apparatuses comprises at least one of the following: a primary admission control apparatus, at least one distributed admission control apparatus, at least one control apparatus, at least one user data management apparatus, or at least one analytics apparatus.

In some example embodiments, the sixth apparatus further comprises: means for performing other operations in some example embodiments of the method 900 or the sixth apparatus 160. In some example embodiments, the means comprises at least one processor; and at least one memory storing instructions that, when executed by the at least one processor, cause the performance of the fifth apparatus.

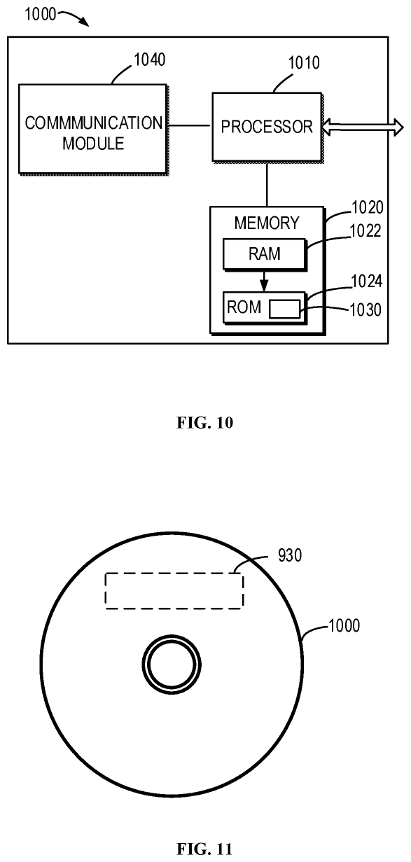

FIG. 10 is a simplified block diagram of a device 1000 that is suitable for implementing example embodiments of the present disclosure. The device 1000 may be provided to implement a communication device, for example, the first device 110, the third device 130, the fourth device 140, the fifth device 150 or the sixth device 160 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has one or more communication interfaces to facilitate communication with one or more other modules or devices. The communication interfaces may represent any interface that is necessary for communication with other network elements. In some example embodiments, the communication module 1040 may include at least one antenna.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The instructions of the program 1030 may include instructions for performing operations/acts of some example embodiments of the present disclosure. The program 1030 may be stored in the memory, e.g., the ROM 1024. The processor 1010 may perform any suitable actions and processing by loading the program 1030 into the RAM 1022.

The example embodiments of the present disclosure may be implemented by means of the program 1030 so that the device 1000 may perform any process of the disclosure as discussed with reference to FIG. 3 to FIG. 9. The example embodiments of the present disclosure may also be implemented by hardware or by a combination of software and hardware.

In some example embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 11 shows an example of the computer readable medium 1100 which may be in form of CD, DVD or other optical storage disk. The computer readable medium 1100 has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-56. (canceled)

57. A first device, comprising:
at least one processor; and
at least one memory storing instructions that, when executed by the at least one processor, cause the first device at least to perform:
receiving, from a second device, a first message for updating or reporting an admission number of user equipments (UEs) or packet data unit (PDU) sessions associated with a serving area corresponding to the second device, the admission number being specific to a slice or single network slice selection assistance information (S-NSSAI); and
determining, a first number of UEs or PDU sessions specific to the slice or the S-NSSAI counted by at least one third device, such that the admission number is verified with the first number; and
performing an admission control procedure based at least in part on the first number.

58. The first device of claim 57, wherein the admission number indicates one of the following:
a maximum admission number allocated to the serving area, or
a current admission number determined by the second device.

59. The first device of claim 57, wherein the first device is further caused to perform:
prior to determining the first number, determining whether it is needed to verify the admission number according to a pre-configured policy associated with at least one of the following:
a threat surface of the second device,
the S-NSSAI,
an identity of public land mobile network (PLMN) corresponding to the first device,
the serving area,
an identity of visited PLMN (VPLMN) corresponding to the second device, or
a security control policy of the serving area.

60. The first device of claim 59, wherein the first device is further caused to perform:
in accordance with a determination that it is not needed to verify the admission number,
performing, based at least in part on the first message, a network slice admission control (NSAC) procedure.

61. The first device of claim 57, wherein determining the first number comprises:
transmitting, to each of the at least one third device, a second message for requesting a second number of UEs or PDU sessions associated with the serving area, the second number being counted by a respective third device of the at least one third device and being specific to the slice or the S-NSSAI;
receiving, from each of the at least one third device, a third message indicating the second number; and
determining the first number by consolidating at least one second number received from the at least one third device.

62. The first device of claim 61, wherein the second message comprises at least one of the following:
the S-NSSAI,
an identity of the serving area,
an identity of visited PLMN (VPLMN) associated with the second device, or
at least one identity of at least one fourth device being located in the serving area, each of the at least one fourth device being a control device.

63. The first device of claim 62, wherein the first device is further caused to perform:
determining the at least one identity of the at least one fourth device according to a mapping of one of the following:
a first mapping of the second device and the at least fourth device, or
a second mapping of the serving area and the at least fourth device.

64. The first device of claim 61, wherein the second number is specific to one of the following:
the second device,
the serving area, or
at least one fourth device being located in the serving area, each of the at least one fourth device being a control device.

65. The first device of claim 61, wherein the first device is further caused to perform:
prior to transmitting the second message to each of the at least one third device,
determining the at least one third device by one of the following:
scanning all accessible third devices, or
performing a discovery procedure of third device according to a pre-configured rule.

66. The first device of claim 57, wherein performing the admission control procedure based at least in part on the first number comprises:
comparing the first number with the admission control number;
if the first number is matched with the admission control number, performing, based at least in part on the first message, a network slice admission control (NSAC) procedure; and
if the first number is mismatched with the admission control number, performing at least one of the following:
stopping the NSAC procedure;
adjusting the admission control number according to the first number; or
transmitting a fourth message to a fifth device, the fourth message indicating that an anomaly has occurred at the second device or in the serving area.

67. The first device of claim 66, wherein the fifth device is a management device.

68. The first device of claim 57, wherein the first device is a primary admission control device, the second device is a distributed admission control device, and the third device a user data management device.

69. A third device, comprising:
at least one processor; and
at least one memory storing instructions that, when executed by the at least one processor, cause the third device at least to perform:
receiving, from a first device, a second message for requesting a second number of user equipments (UEs) or packet data unit (PDU) sessions associated with a serving area corresponding to a second device, the second number being counted by the third device and being specific to a slice or single network slice selection assistance information (S-NSSAI);
generating a third message indicating the second number; and
transmitting the third message to the second device.

70. The third device of claim 69, wherein the second message comprises at least one of the following:
the-NSSAI,
an identity of the serving area,
an identity of visited PLMN (VPLMN) associated with the second device, or
at least one identity of at least one fourth device being located in the serving area, each of the at least one fourth device being a control device.

71. The third device of claim 69, wherein the second number is specific to one of the following:
the second device,
the serving area,
at least one fourth device being located in the serving area, each of the at least one fourth device being a control device.

72. The third device of claim 69, wherein the third device is further caused to perform:
receiving, from a fourth device, a fifth message comprising information on one or more allowed single network slice selection assistance information (S-NSSAI), the fifth message being transmitted by the fourth device in response to a complete of registration for user equipment, the fourth device being an access and mobility management function (AMF).

73. The third device of claim 69, wherein the first device is a primary admission control device or an analytics device, the second device is a distributed admission control device, and the third device a user data management device.

74. A fourth device, comprising:
at least one processor; and
at least one memory storing instructions that, when executed by the at least one processor, cause the fourth device at least to perform:
receiving, from user equipment, a registration request; and
in response to a complete of registration for the user equipment, transmitting, to a third device, a fifth message comprising information on one or more allowed single network slice selection assistance information (S-NSSAI).

75. The fourth device of claim 74, wherein the fourth device is an access and mobility management function (AMF), and the third device is a user data management device.
